(19) United States
(12) Patent Application Publication
(10) Pub. No.: US 2008/0249787 A1
(43) Pub. Date: Oct. 9, 2008

(54) ORGANIZATIONAL CONSENSUS SYSTEMS AND METHODS

(76) Inventor: Michael J. Harrison, Austin, TX (US)

Correspondence Address: COHEN & GRIGSBY, P.C., 11 STANWIX STREET, 15TH FLOOR, PITTSBURGH, PA, 15222, US

(21) Appl. No.: 11/696,757

(22) Filed: Apr. 5, 2007

(51) Int. Cl. G06Q 10/00

(52) U.S. Cl. 705/1

(57) ABSTRACT

A computer-assisted method of determining whether an agreement threshold as to a composition of a topic list has been reached by a plurality of participants. The method includes at least one of adding, modifying and deleting, by at least one of the participants, an entry on the topic list and calculating an agreement score relating to a percentage of the participants that agree as to the composition of the topic list. The method also includes comparing the agreement score with the agreement threshold, creating a final topic list when the agreement score is greater than or equal to the agreement threshold and repeating the method when the agreement score is less than the agreement threshold.

### BACKGROUND

It is often desirable for organizations and units within an organization to establish a consensus position on a particular topic. For example, a manager of a department may desire to obtain a consensus among department members as to what skills are necessary for an employee of the department to be proficient in a particular job description. Using current methods, the manager would have to poll the employees of the department, collate the information from the polling, and determine from the information what the employees believe the necessary skills are. Although this process may in some instances be a manageable one, when a consensus among participants in a large group is needed, the process becomes unwieldy and oftentimes expensive.

### SUMMARY

In various embodiments, the present invention is directed to a computer-assisted method of determining whether an agreement threshold as to a composition of a topic list has been reached by a plurality of participants. The method includes at least one of adding, modifying and deleting, by at least one of the participants, an entry on the topic list and calculating an agreement score relating to a percentage of the participants that agree as to the composition of the topic list. The method also includes comparing the agreement score with the agreement threshold, creating a final topic list when the agreement score is greater than or equal to the agreement threshold and repeating the method when the agreement score is less than the agreement threshold.

In various embodiments, the present invention is directed to a system for determining whether an agreement threshold as to a composition of a topic list has been reached by a plurality of participants. The system includes means for at least one of adding, modifying and deleting, by at least one of the participants, an entry on the topic list, means for calculating an agreement score relating to a percentage of the participants that agree as to the composition of the topic list and means for comparing the agreement score with the agreement threshold. The system also includes means for creating a final topic list when the agreement score is greater than or equal to the agreement threshold and means for repeating the method when the agreement score is less than the agreement threshold.

In various embodiments, the present invention is directed to a computer readable medium having stored thereon instructions which, when executed by a processor, cause the processor to:

facilitate adding, modifying and deleting, by at least one of a plurality of participants, an entry on a topic list;

calculate an agreement score relating to a percentage of the participants that agree as to composition of the topic list;

compare the agreement score with an agreement threshold;

create a final topic list when the agreement score is greater than or equal to the agreement threshold; and

repeat the method when the agreement score is less than the agreement threshold.

In various embodiments, the present invention is directed to a system. The system includes a consensus engine that includes a participant topic management module configured to facilitate at least one of adding, modifying and deleting, by at least one of the participants, an entry on a topic list. The consensus engine is configured to calculate an agreement score relating to a percentage of the participants that agree as to a composition of the topic list and compare the agreement score with an agreement threshold. The system also includes a facilitator topic management module configured to create a final topic list when the agreement score is greater than or equal to the agreement threshold.

Those and other details, objects, and advantages of the present invention will become better understood or apparent from the following description and drawings showing embodiments thereof.

### BRIEF DESCRIPTION OF THE DRAWINGS

The accompanying drawings illustrate examples of embodiments of the invention. In such drawings:

FIG. 1 illustrates an embodiment of a system that may be used to obtain a consensus among participants;

FIG. 2 illustrates an embodiment of a process for obtaining a consensus among participants;

FIG. 3 illustrates an embodiment of a process by which a participant can edit a topic list;

FIG. 4 illustrates an embodiment of a process by which a facilitator can perform actions relating to a consensus building process;

FIG. 5 illustrates an embodiment of a process for calculating an agreement score;

FIG. 6 illustrates an embodiment of a process for creating and managing group composition; and

FIGS. 7A through 7C illustrate an embodiment of a process for creating and managing topics.

### DESCRIPTION

As used herein, the term “topic” means any subject, question, matter of discussion, or any item of interest or concern to an organization or group of people. As used herein, the term “group” means any organization, whether formally organized or loosely affiliated, or any portion thereof. As used herein, the term “participant” means any person or entity that participates in a consensus gathering process.

Various embodiments of the present invention utilize an iterative technique that allows a threshold level of consensus among participants to be specified. Participants have the ability to add, modify and delete entries in a topic list until the threshold level of consensus has been reached. Various embodiments may be used to determine a comprehensive list of skills within an organization by finding the skills needed for each job position and combining the list of skills for each job position. For example, a manager in an organization could specify that 85% agreement among employees is needed on the required entries that make up a specific job position. In each iteration of a consensus process, each employee specifies the skills that the employee believes are required for the specific job position and the skills are added to a skills list. The iterative process continues until the employees have agreed upon 85% of the skills present in the skills list created by the employees.

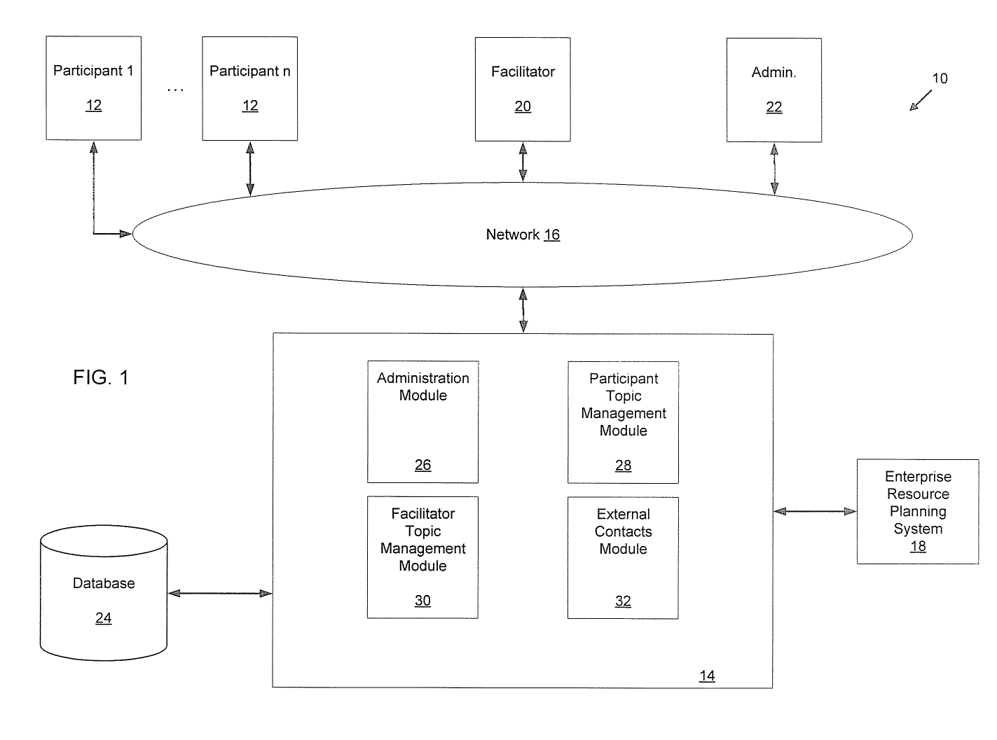

FIG. 1 illustrates an embodiment of a system 10 that may be used to obtain a consensus among participants 12. The participants 12 are in communication with a consensus engine 14 via, for example, a network 16. The network 16 may be, for example, a local area network (LAN), a wide area network (WAN), an intranet, the Internet, or any other type of suitable network.

The consensus engine 14 may be in communication with an enterprise resource planning (ERP) system 18, such as those marketed by Oracle, SAP, Baan and JD Edwards. The ERP system 18 may communicate data, such as data associated with the participants 12 and facilitator 20 to the engine 14. The data may be communicated periodically (e.g., nightly) or whenever necessary or desirable for operation of the system 10. The data imported from the ERP system 18 may include data relating to, for example, the job description, job location, and unit (e.g., department) to which the participants 12 belong in a group. The engine 14 may be in communication with the system 18 via, for example, a dedicated network, the network 16, the Internet, etc. Data may be obtained from the system 18 directly or read from a file (e.g., an XML, or flat text file) to which data from the system 18 is exported.

An administrator 22 may be in communication with the engine 14 via the network 16. The administrator 22 may be a user who has administrative rights in the engine 14. The facilitator 20 is a user who is responsible for managing and facilitating the consensus process that is performed by the engine 14. The system 10 also includes a database 24 that is used by the engine 14 to store, for example, data collected by and relating to the operation of the system 10 and the users 12, 20 and 22.

The engine 14 includes an administration module 26 that may be used by the administrator 22 to perform various administrative functions such as, for example, creating user rights and access privileges. A participant topic management module 28 is used by the participants 12 to add, delete and modify topics on a topic list during a consensus process. A facilitator topic management module 30 is used by the facilitator 20 to add, delete and modify topics on a topic list during a consensus process. A consensus module 32 facilitates the consensus process as described hereinbelow in which the participants 12 modify a topic list until a threshold percentage of agreement, as set by the facilitator 20, is met.

In various embodiments, the engine 14 may be implemented in computer software. By way of example, the engine 14 may be implemented in, for example, Flash using the ColdFusion development framework.

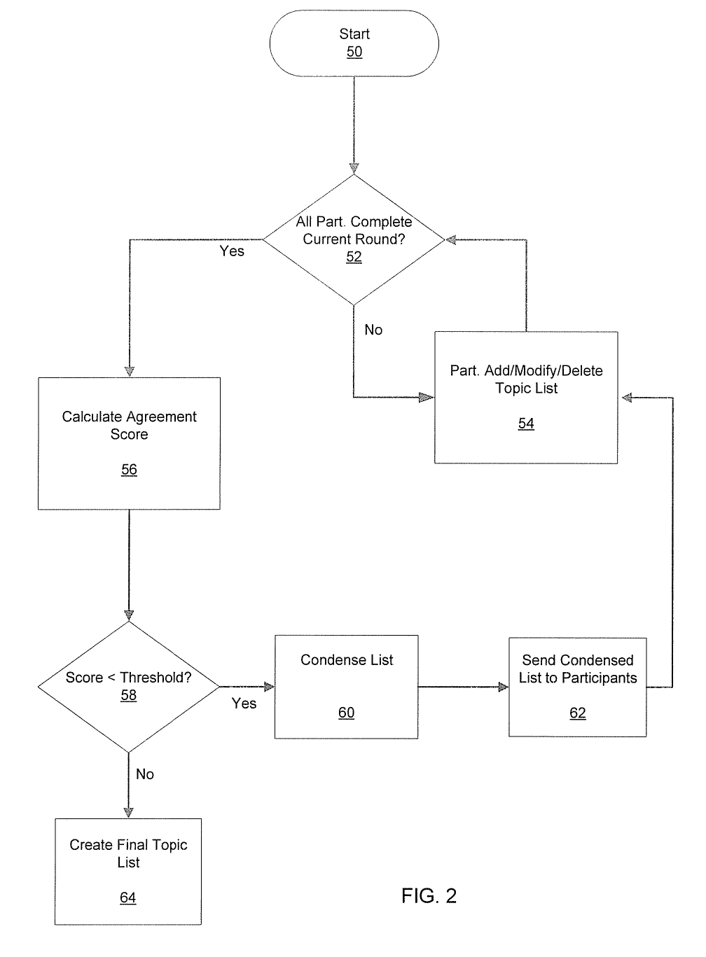

FIG. 2 illustrates an embodiment of a process for obtaining a consensus among the participants 12. The process illustrated in FIG. 2 may be performed by the consensus module 32. The process starts at 50 and at 52 the process determines whether all participants 12 in the process have completed the current round of topic list editing. If all participants 12 have not completed the current round, the remaining participants 12 complete the round by editing, adding or deleting entries from the topic list at 54.

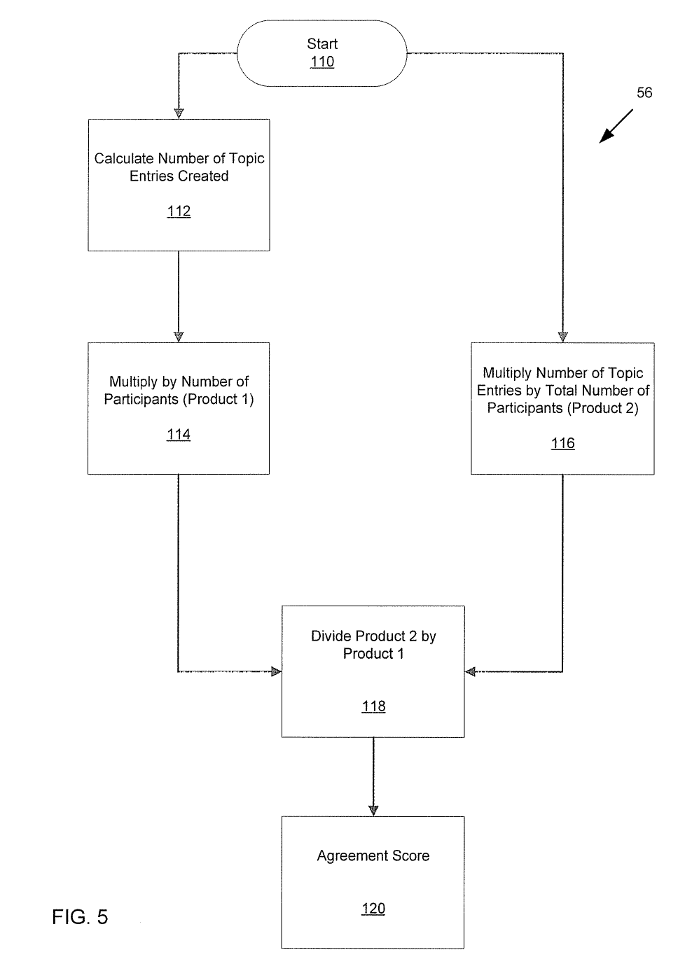

At 56 the process calculates the agreement score as described hereinbelow in conjunction with FIG. 5. At 58 the process determines whether the calculated agreement score is less than a threshold score that is set by the facilitator 20. If the score is less than the threshold, the topic list is condensed by, for example, the facilitator 20 and the condensed topic list is sent to the participants 12 at 62. If the calculated score is greater than or equal to the threshold, a final topic list is created at 64 by, for example, the facilitator 20. The final topic list is based on the latest iteration of the topic list for which the agreement score was greater than or equal to the threshold. The final topic list may be stored in, for example, the database 24.

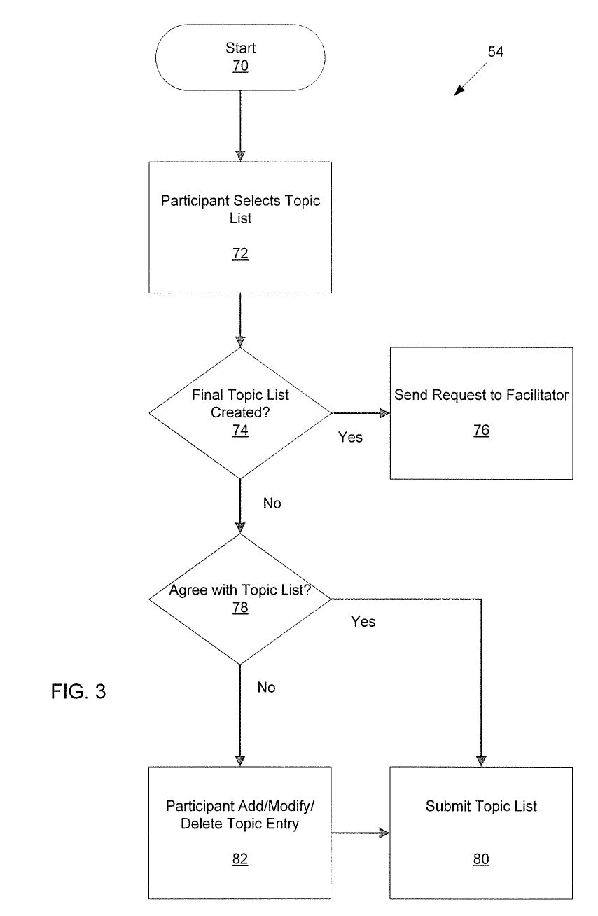

FIG. 3 illustrates an embodiment of a process by which a participant 12 can edit a topic list. The process starts at 70 and at 72 the participant 12 selects the topic list that the participant 12 desires to edit. At 74, if the topic list has been finalized, the participant 12 can send a request to the facilitator 20 to edit the topic list at 76. If the topic list has not been finalized at 74, the participant 12 determines whether the participant 12 agrees with the list at 78. If the participant 12 agrees with the list at 78, the participant 12 submits the topic list at 80. If the participant 12 does not agree with the list at 78, the participant 12 can add, modify, or delete topics from the topic list at 82 before submission at 80.

In various embodiments, the participant 12 is sent a confirmation that successful editing of the topic list has been accomplished. In various embodiments the facilitator 20 is notified when the participant edits the topic list.

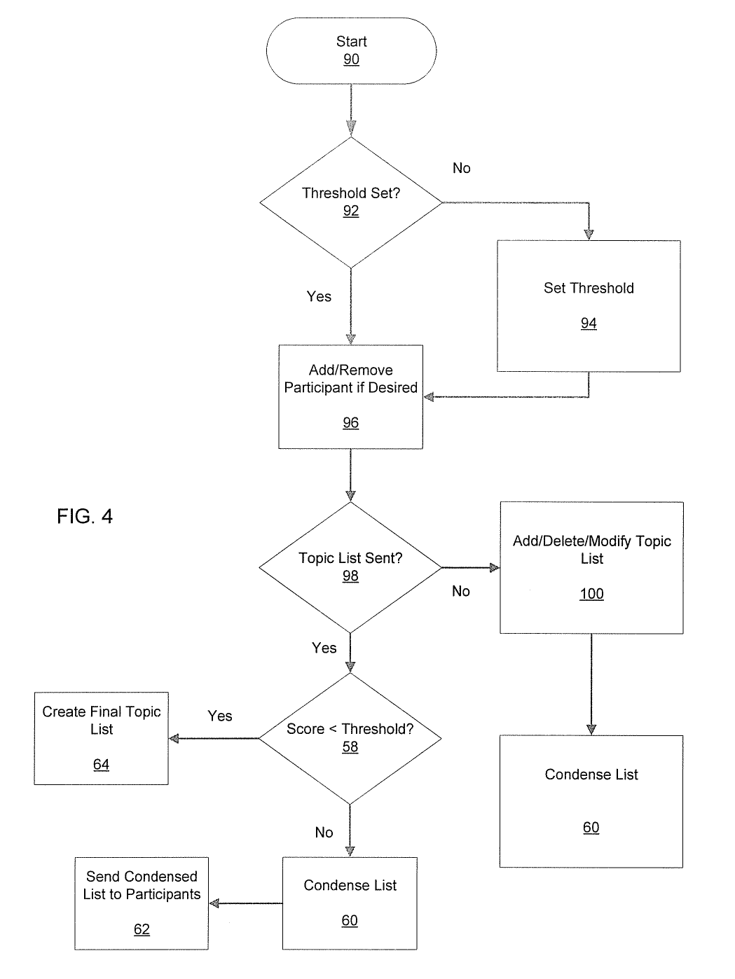

FIG. 4 illustrates an embodiment of a process by which a facilitator 20 can perform actions relating to a consensus building process. The process starts at 90 and at 92 it is determined whether the agreement threshold for a topic list has been specified by the facilitator 20. If the threshold has not been specified, the facilitator 20 may do so at 94. If the threshold has been set, the facilitator 20 may add or remove participants 12 to whom the topic list is routed at 96. At 98 the process determines whether the topic list has been sent to the participants 12 at least once. If the topic list has not been sent to the participants 12 at least once, the facilitator 20 may add, delete or modify topic entries that are present on the topic list at 100. The facilitator 20 may send the topic list to the participants 12 at 102. If the topic list was sent to participants 12 at 98, the process proceeds as described hereinabove in conjunction with FIG. 2 at 58, 60, 62 and 64.

FIG. 5 illustrates an embodiment of a process for calculating an agreement score. The process starts at 110 and at 112 the number of topic entries created by all the participants 12 is calculated. At 114 the total number of participants 12 is multiplied by the number of topic entries created by all the participants 12 to create a first product. At 116 the total number of topic entries selected by all participants 12 is multiplied by the total number of participants 12 to create a second product. At 118 the second product is divided by the first product to arrive at an agreement score 120.

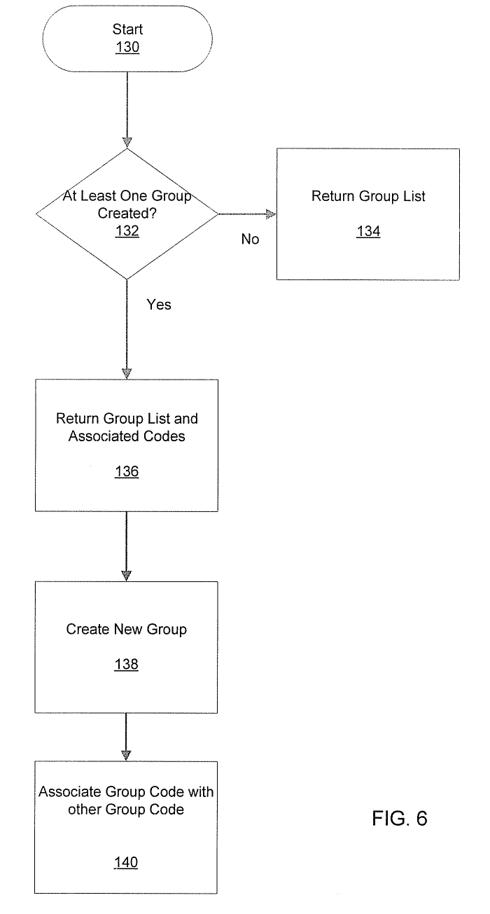

FIG. 6 illustrates an embodiment of a process for creating and managing group composition. The process starts at 130 and at 132 determines whether at least one group of participants 12 has been created. If at least one group has not been created, a list of groups is returned at 134. At 136, if at least one group has been created at 132, a list of groups along with associated group codes are returned. At 138 a new group may be created and at 140 a code associated with the newly-created group may be associated with other group codes if desired. In various embodiments, groups may be nested within groups so that, for example, department names may be created with nested departmental codes so that department names are easily recognizable by employees (participants 12) within such departments.

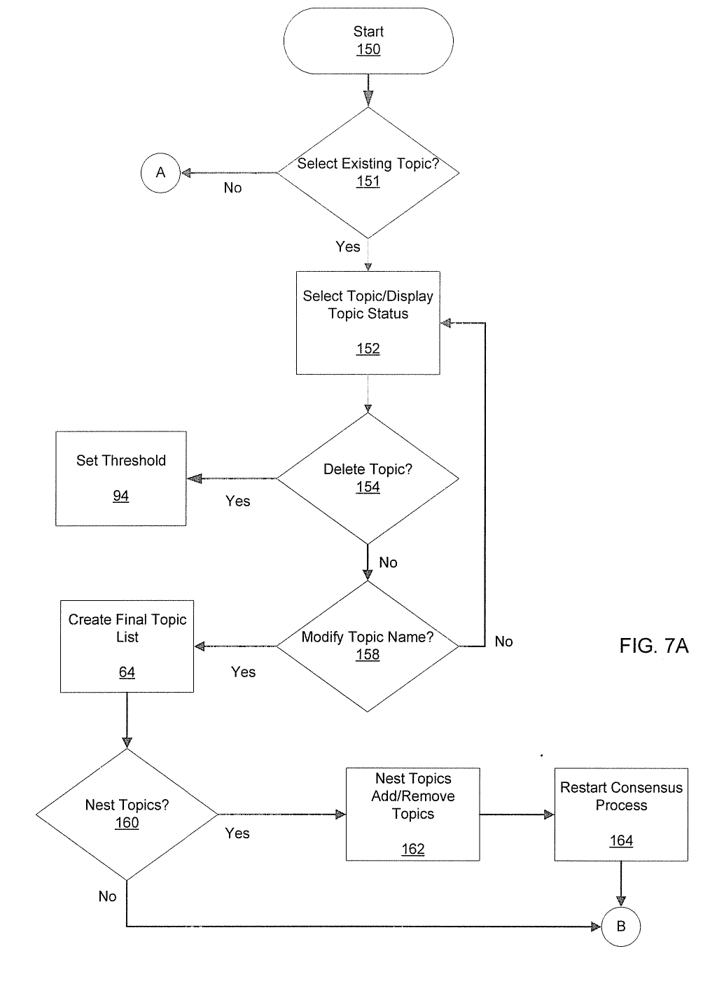

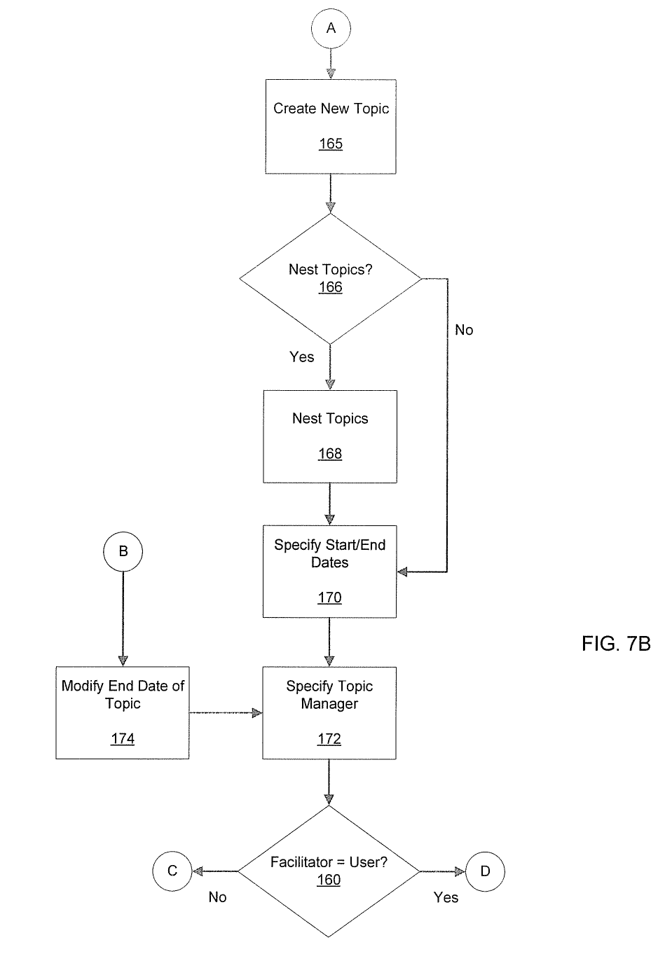

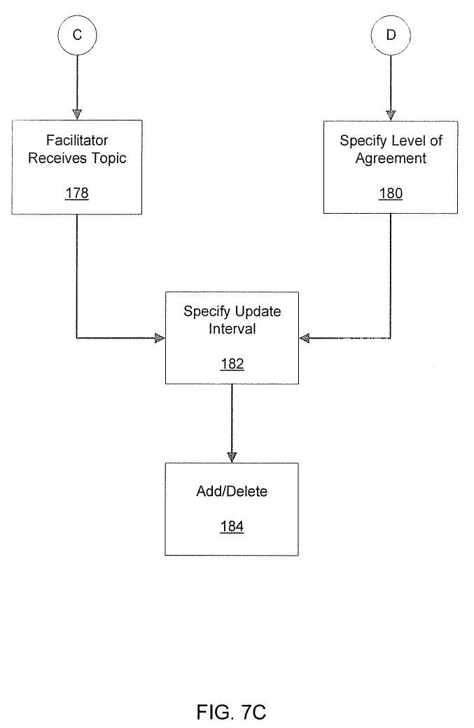

FIGS. 7A through 7C illustrate an embodiment of a process for creating and managing topics. The process illustrated in FIGS. 7A through 7C may be performed by, for example, the facilitator 20 or the administrator 22. The process starts at 151 in FIG. 7A where the user is prompted as to whether the user would like to select an existing topic. If so, the process advances to 152 where the user may select a topic from a list of existing topics and the status of the topic is displayed. Displayed information may include, for example, a list of the participants 12 associated with the topic and the role that they play in their associated group, the number of iterations for which the consensus process of FIG. 2 has gone through, the current percentage of consensus for the topic and a list of topic entries for the topic.

At 154 the user is prompted to specify whether the user would like to delete the selected existing topic. If so, the topic is deleted at 156. If the user does not want to delete an existing topic, the user is prompted to specify whether the user would like to modify the topic name of the selected topic at 158. If the user wants to modify the topic name, the topic name is modified at 159 and the user is prompted to specify whether the user would like to nest one topic within another at 160. If so, the user may nest one or more topics within each other and may add or remove one or more nested topics at 162. The process advances to 164 where the consensus process of FIG. 2 is restarted using the modifications made by the user.

If the user decided to not select an existing topic at 151, the process advances to 165 in FIG. 7B, where the user creates a new topic. At 166 the user is prompted to specify whether the user would like to nest one topic within another. If so, the user may nets one or more topics within each other at 168. At 170 the user is prompted to specify the start and end dates for the new topic and at 172 the user is prompted to identify the facilitator for the new topic. Also, at 174 the user may modify the end date of a topic before proceeding to 172.

At 176 the process determines whether the user is also the facilitator 20 for the selected topic. If not, the process transmits the topic to the facilitator 20 at 178 in FIG. 7C. If the user is also the facilitator 20, the user specifies the level of agreement for the topic at 180 in FIG. 7C. At 182 the user specifies the interval for which the selected topic is updated. In various embodiments, the interval may range from never to daily. At 184 the user may add or delete group names or participants 12 that are associated with the selected topic.

Various embodiments of the present invention may be implemented on computer-readable media. The terms “computer-readable medium” and “computer-readable media” in the plural as used herein may include, for example, magnetic and optical memory devices such as diskettes, compact discs of both read-only and writeable varieties, optical disk drives, hard disk drives, etc. A computer-readable medium may also include memory storage that can be physical, virtual, permanent, temporary, semi-permanent and/or semi-temporary. A computer-readable medium may further include one or more data signals transmitted on one or more carrier waves.

While the foregoing has been set forth in considerable detail, it is to be understood that the drawings and detailed embodiments are presented for elucidation and not limitation. Design variations may be made but are within the principles of the invention. Those skilled in the art will realize that such changes or modifications of the invention or combinations of elements, variations, equivalents, or improvements therein are still within the scope of the invention as defined in the appended claims.

What is claimed is:

1. A computer-assisted method of determining whether an agreement threshold as to a composition of a topic list has been reached by a plurality of participants, the method comprising:
at least one of adding, modifying and deleting, by at least one of the participants, an entry on the topic list;
calculating an agreement score relating to a percentage of the participants that agree as to the composition of the topic list;
comparing the agreement score with the agreement threshold;
creating a final topic list when the agreement score is greater than or equal to the agreement threshold; and
repeating the method when the agreement score is less than the agreement threshold.

2. The method of claim 1, wherein calculating an agreement score includes:
calculating a number of topic entries created by the participants;
multiplying the number of topic entries created by the participants by a total number of the participants to create a first product;
multiplying a total number of topic entries by the total number of the participants to create a second product; and
dividing the second product by the first product to arrive at the agreement score.

3. The method of claim 1, further comprising editing, by at least one of the participants, the topic list.

4. The method of claim 3, wherein editing includes editing by at least one of the participants when the at least one of the participants does not agree with the topic list.

5. The method of claim 1, further comprising setting, by a facilitator, the agreement threshold.

6. The method of claim 1, wherein creating a final topic list is performed by a facilitator.

7. The method of claim 1, further comprising condensing, by a facilitator, the topic list.

8. The method of claim 1, further comprising creating at least one group that includes at least one of the participants.

9. The method of claim 1, further comprising creating, by a facilitator, a topic to be included on the topic list.

10. The method of claim 1, further comprising nesting, by a facilitator, a plurality of topics on the topic list.

11. A system for determining whether an agreement threshold as to a composition of a topic list has been reached by a plurality of participants, the system comprising:
means for at least one of adding, modifying and deleting, by at least one of the participants, an entry on the topic list;
means for calculating an agreement score relating to a percentage of the participants that agree as to the composition of the topic list;
means for comparing the agreement score with the agreement threshold;
means for creating a final topic list when the agreement score is greater than or equal to the agreement threshold; and
means for repeating the method when the agreement score is less than the agreement threshold.

12. The system of claim 11, wherein the means for calculating an agreement score includes:
means for calculating a number of topic entries created by the participants;
means for multiplying the number of topic entries created by the participants by a total number of the participants to create a first product;
means for multiplying a total number of topic entries by the total number of the participants to create a second product; and
means for dividing the second product by the first product to arrive at the agreement score.

13. A computer readable medium having stored thereon instructions which, when executed by a processor, cause the processor to:
facilitate adding, modifying and deleting, by at least one of a plurality of participants, an entry on a topic list;
calculate an agreement score relating to a percentage of the participants that agree as to composition of the topic list;
compare the agreement score with an agreement threshold;
create a final topic list when the agreement score is greater than or equal to the agreement threshold; and
repeat the method when the agreement score is less than the agreement threshold.

14. A system, comprising:
a consensus engine comprising:
a participant topic management module configured to facilitate at least one of adding, modifying and deleting, by at least one of the participants, an entry on a topic list;
wherein the consensus engine is configured to:
calculate an agreement score relating to a percentage of the participants that agree as to a composition of the topic list; and
compare the agreement score with an agreement threshold; and
a facilitator topic management module configured to create a final topic list when the agreement score is greater than or equal to the agreement threshold.

15. The system of claim 14, further comprising an enterprise resource planning system in communication with the consensus engine.

16. The system of claim 14, further comprising an administration module.

17. The system of claim 14, further comprising a database in communication with the consensus engine.

18. The system of claim 14, further comprising a network configured to enable communications between the participants and the consensus engine.
